(19) United States
(12) Patent Application Publication
(10) Pub. No.: US 2014/0134921 A1
(43) Pub. Date: May 15, 2014

(54) MULTI-UNIT BEEHIVE

(71) Applicant: Iurii Silvestrovych Dron, Chernivtsi (UA)

(72) Inventor: Iurii Silvestrovych Dron, Chernivtsi (UA)

(21) Appl. No.: 14/125,357

(22) PCT Filed: Mar. 15, 2012
(86) PCT No.: PCT/UA2012/000027

§ 371 Date: Dec. 11, 2013

(30) Foreign Application Priority Data
Jun. 20, 2011 (UA) A2011 07712

(51) Int. Cl. A01K 47/00

(52) U.S. Cl. CPC A01K 47/00
USPC 449/32

(57) ABSTRACT

Field of use: The invention relates to beekeeping, in particular to beehive designs.

The essence of the invention: A right-angled opening is formed in the bottom of a multi-unit beehive, which has larger and smaller housings combined into the same frame, in which opening a filled smaller housing can be mounted, and a brood nest is further expanded by filling a larger housing with the required number of frames.

The technical result: An improvement of the expansion conditions of the bee nest by it not being necessary to completely dismantle the small housing and by it being possible to add the required number of frames for the expansion of a larger housing.

The invention relates to beekeeping, in particular to beehive designs. It can be used either in commercial or in hobby beekeeping.

It is a well-known fact that after a winter period of time a bee colony begins to develop rapidly, making a significant increasing in size. Thus, during spring and summer periods of time the beekeepers must gradually expand the bee nests. There is a great variety of ways concerning the expansion of bee nests. A necessary dimension in the long hives is gradually increased by adding 1 or 2 new frames at its both sides, which are quickly adapted by bees. The expansion of nest in the multi-unit beehive is implemented by setting the additional housings containing 10 frames at top or bottom of a housing, used by bees. Such a drastic increase dimension is highly stressful for bee colonies, which very often, especially in adverse weather conditions, can not only warm a housing and adapt to it immediately, but also it can slow their development.

Beekeeping in a well-known multi-unit beehive of I. S. Dron (the Ukrainian patent for invention No. 94494, published in May 10, 2011, bulletin No. 9, 2011) is a prototype, which suggests two possible extensions of bee nests. According to the first method, a fully adapted smaller housing is mounted onto a larger one with a full set of frames in it (at least 10). The second method involves the nest transfer from the smaller housing to the larger one. That is, all the frames of a smaller housing are installed into the larger one, and after such kind of expansion are put into effect by substituting the separate frames into a larger housing. However, after filling the last one, a further expansion is also put into effect by installing a whole smaller housing, fully completed with the frames. Furthermore, the implementation of this method requires significant labour inputs while transferring all the frames from a smaller housing to a larger one. It also brings a lot of stress to the bee colony.

The main principles of the invention are to improve the keeping of bee colonies, also to improve the conditions of its bee nests expansion. A formulated problem can be solved by the following: a multi-unit beehive consists of a bottom, roof, larger and smaller right-angled housings with the same size frames. Besides, the housings can be mounted one above the other, as well as a smaller housing can be placed in a larger one. Hence, according to the proposed decision, there is a right-angled opening in the bottom, where a smaller body can be easily installed.

The improvement of bee colonies keeping and the conditions of bee nest expansion are achieved by the installation of adapted by bees a smaller housing in right-angled bottom opening, and further expansion by means of new frames installation into a larger housing. Thereby, there is no need to disassemble a smaller housing. The number of frames added into the larger housing depends on external conditions and the strength of bee colonies.

In winter the bottom opening is completely or partially (for the purpose of ventilation) blocked. The smaller housing with frames is installed on the overlap inside the larger housing. In order to have the access to the smaller housing installed on the bottom opening without mounting the larger one, there is the opening in one of the bottom walls, with a help of which the smaller housing by means of horizontal displacement can be removed or mounted into the bottom opening. The opening is tightly closed by a wooden board with bee-entrance.

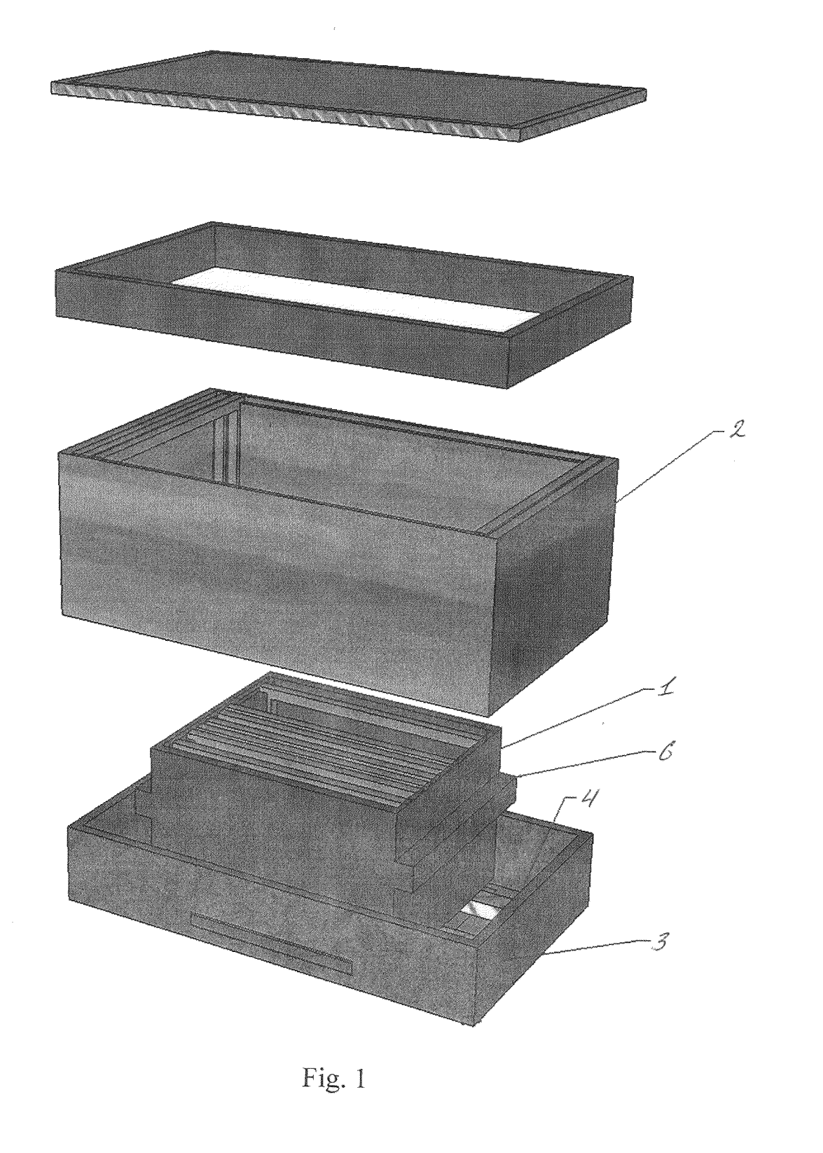

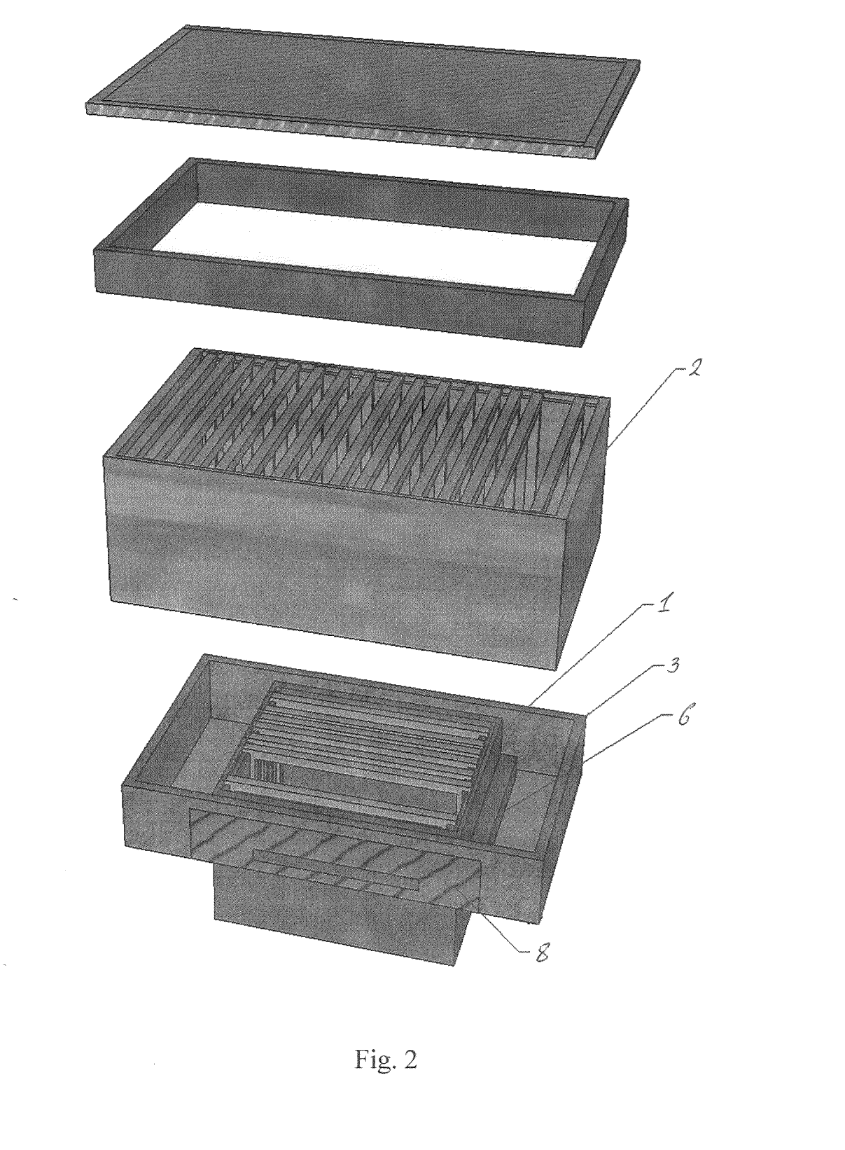

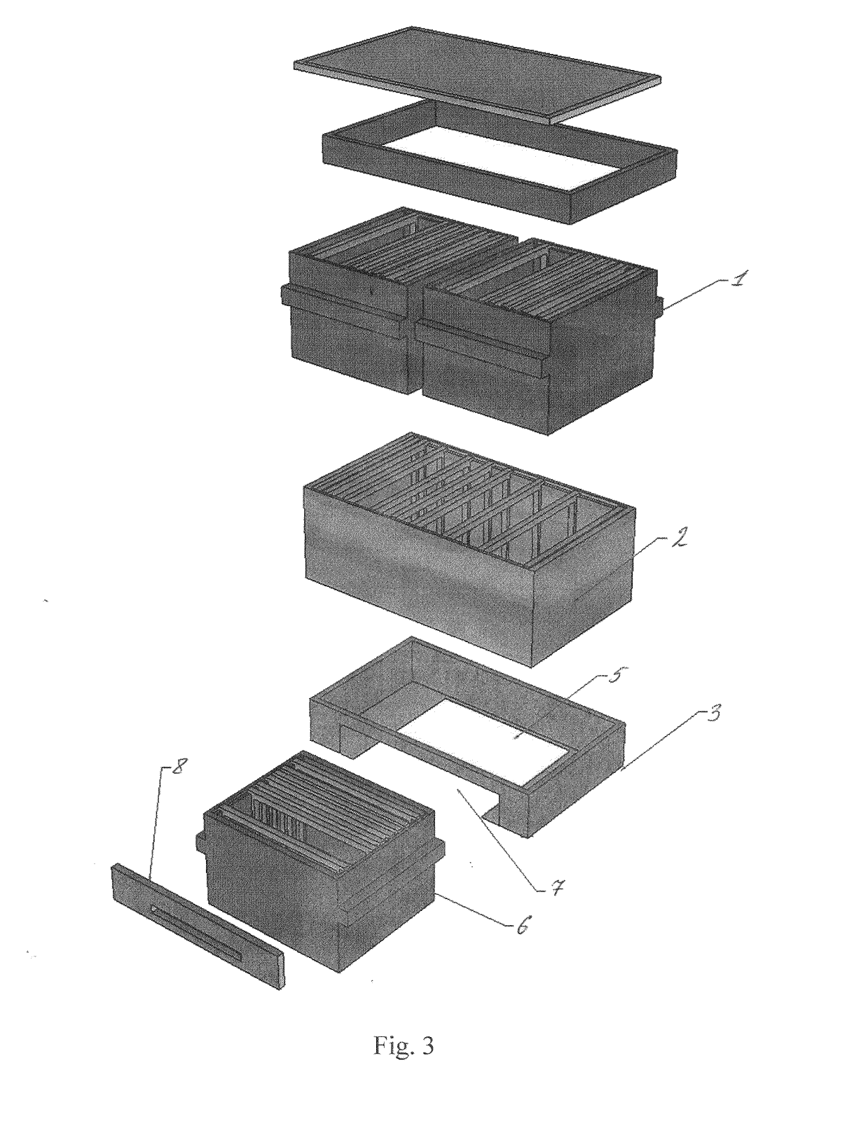

A schematic mounting of winter hive, where the smaller housing is installed into a larger one, is presented in FIG. 1. The summer configuration is presented in FIG. 2. FIG. 3 describes the main components of the proposed hive.

The usage of proposed hive in its simple form can be put into effect as follows. Four vertical pickets, plugged into the ground, are fixed at the sides of the bottom. Whereby, the bottom of the hive is mounted horizontally at the height of 40-50 cm above the ground. In winter (FIG. 1) the bee nest is located in the smaller housing 1, which is mounted in the larger housing 2. The smaller housing is leaned by a lower part of the walls on mountings 4 (e.g. a sheet of plywood or wooden boards), mounted on the bottom of the hive 3.

To expand the dimension of the hive in spring, the mountings 4 are removed and the smaller housing 1 without disassemble is installed into the bottom opening 5 (FIG. 2). For this purpose, the side walls of the smaller housing 1 have the fixed wooden boards 6 at a certain height, which help it to lean on the bottom of the hive. The height of wooden boards mounting is such that in this housings position the distance between the lower part of the frames of the larger housing 2 and the top part of the frame of the smaller housing 1 is not more than 1 centimeter. A direct expansion of nest is made by mounting the required number of frames into the larger housing 2.

In order to have the access to the smaller housing 1 in the bottom opening 5 without disassemble of the larger housing 2 in one of the bottom walls 3 (a front one) there is the opening 7. With a help of this opening the smaller housing 1 by means of horizontal displacement can be removed or mounted in the bottom opening 5 (FIG. 3). The opening 7 is tightly closed by the wooden board 8 with bee-entrance.

The proposed hive can be produced by means of modern technology and industry.

1. A multi-unit beehive consists of a bottom, a roof, larger and smaller housings of a right-angled form with the same frames, moreover its housings can be installed one above the other and in case of turning in the horizontal plane by 90° the smaller housing can be installed into the larger one, a distinguished feature of which is a right-angled opening in the bottom for smaller housing installation.

2. A multi-unit beehive as defined in claim 1, in which one of the bottom wall has the opening for installation of the smaller housing into a right-angled bottom opening by means of horizontal displacement.
